(19) United States
(12) Patent Application Publication
(10) Pub. No.: US 2014/0087833 A1
(43) Pub. Date: Mar. 27, 2014

(54) GAMING DEVICE HAVING MULTI-POSITIONAL GAME ELEMENTS

(71) Applicant: KING SHOW GAMES, INC., Minnetonka, MN (US)

(72) Inventor: Bradley BERMAN, Minnetonka, MN (US)

(73) Assignee: KING SHOW GAMES, INC., Minnetonka, MN (US)

(21) Appl. No.: 14/015,473

(22) Filed: Aug. 30, 2013

Related U.S. Application Data
(60) Provisional application No. 61/705,538, filed on Sep. 25, 2012.

(51) Int. Cl. G07F 17/32

(52) U.S. Cl. CPC G07F 17/3267
USPC 463/20

(57) ABSTRACT

Embodiments of the present concept include providing gaming devices, gaming systems, and methods of operating these devices or systems to provide game play that utilizes multi-positional game elements. In one instance, a method of operating a gaming device includes mapping a portion of possible symbols to the multi-positional game elements according to one or more predefined rules for use in one or more gaming events. In an alternative instance, multiple symbols are selected from a plurality of available symbols and assigned to each position of one or more multi-positional game elements for use in one or more gaming events.

### RELATED APPLICATIONS

This application claims the benefit of Provisional Patent Application No. 61/705,538, filed on Sep. 25, 2012, to which priority is claimed pursuant to 35 U.S.C. §119(e) and which is incorporated herein by reference in its entirety.

### FIELD OF THE INVENTION

This disclosure relates generally to games, and more particularly to apparatuses and methods for wagering games that map multiple possible game indicia symbols to multi-positional game elements.

### BACKGROUND

Casino games such as poker, slots, and craps have long been enjoyed as a means of entertainment. Almost any game of chance that can be played using traditional apparatus (e.g., cards, dice) can be simulated on a computer. The popularity of casino gambling with wagering continues to increase, as does recreational gambling such as non-wagering computer game gambling. It is also likely that most new games will be implemented, at least in part, using computerized apparatus.

One reason that casino games are widely implemented on computerized apparatus is that computerized games are highly adaptable, easily configurable and re-configurable, and require minimal supervision to operate. For example, the graphics and sounds included in such games can be easily modified to reflect popular subjects, such as movies and television shows.

Computer gaming devices can also be easily adapted to provide entirely new games of chance that might be difficult to implement using mechanical or discrete electronic circuits. Because of the ubiquity of computerized gaming machines, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill. In some jurisdictions, the absence of skill when determining awards during game play is a requirement.

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, the present invention is directed to an apparatus, system, computer readable storage media, and/or method that involve or otherwise facilitate mapping possible game indicia symbols (also referred to as markings) to each position of multi-positional game elements. In one embodiment, a gaming device includes a display, a player interface, and a processor that is configured to select symbols from a group of symbols to display on sides of one or more multi-positional game elements used during game play according to one or more predefined rules. In another embodiment, a method includes assigning thirty playing card indicia symbols from the fifty two possible card values in a standard playing card deck to each face of five six-sided cubes for play of a game event on a gaming device.

### BRIEF DESCRIPTION OF THE DRAWINGS

FIG. 1 is a diagram of a gaming machine according to embodiments of the invention.

FIG. 2 is a diagram of possible game indicia symbols that can be mapped to multi-positional game elements according to embodiments of the invention.

FIG. 3 is diagram representative of an example embodiment where poker game symbols are mapped to multi-positional game elements.

FIG. 4 is diagram of a game display showing another example embodiment where game symbols are mapped to multi-positional game elements and evaluated in various combinations.

FIG. 5 is a flow diagram illustrating a method of mapping poker card values to one or more multi-positional game elements according to embodiments of the invention.

FIG. 6 is a flow diagram illustrating another method of mapping poker card values to one or more multi-positional game elements according to embodiments of the invention.

FIG. 7 is a flow diagram illustrating a method of operating a gaming device to play a game having poker card values mapped to one or more multi-positional game elements according to embodiments of the invention.

FIGS. 8A-8H are diagrams of a game display showing an example game progression using multi-position game elements according to embodiments of the invention.

FIG. 9 is a flow diagram illustrating a method of operating a gaming device to play a gaming event using multi-positional game elements according to embodiments of the invention.

FIGS. 10A-10F are diagrams of a game display showing an example game progression using multi-position game elements according to embodiments of the invention.

FIG. 11 is a diagram of a game display showing a gaming event having multi-position game elements according to embodiments of the invention.

FIG. 12 is a flow diagram illustrating a method of operating a gaming device to play a gaming event using multi-positional game elements according to embodiments of the invention.

FIGS. 13A and 13B are diagrams of a game display showing an example game progression using multi-position game elements according to embodiments of the invention.

FIGS. 14A-14D are diagrams of a game display showing an example game progression using multi-position game elements according to embodiments of the invention.

FIG. 15 is a block diagram illustrating a computing arrangement according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the term “reels,” “cards,” “decks,” and similar mechanically descriptive language may be used to describe various apparatus presentation features, as well as various actions occurring to those object (e.g., “spin,” “draw,” “hold,” “bet”). Although the present disclosure may be applicable to both to manual, mechanical, and computerized embodiments, and any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for enhancing winning result opportunities in gaming activities. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. poker) are provided for purposes of facilitating an understanding of the features described herein. However, the principles described herein are equally applicable to any game of chance where an outcome(s) is determined for use in the player's gaming activity. The game features described herein may be employed in stand-alone games, a primary/base games, bonus games, side bet games, etc.

Embodiments of the present concept include providing gaming devices (also referred to as gaming apparatuses or gaming machines), gaming systems, and methods of operating these devices or systems to provide game play that utilizes multi-positional game elements. In one embodiment, a method of operating a gaming device includes mapping a portion of possible symbols to the multi-positional game elements according to one or more predefined rules for use in one or more gaming events. In other embodiments, multiple symbols are selected from a plurality of available symbols and assigned to each position of one or more multi-positional game elements for use in one or more gaming events. Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve poker-based gaming event examples of this concept, other embodiments include application of these concepts in other types of poker games, slot games, or other games of chance. Some of these other types of embodiments will be discussed below as variations to the examples illustrated. However, many other types of games can implement similar techniques and fall within the scope of this inventive concept.

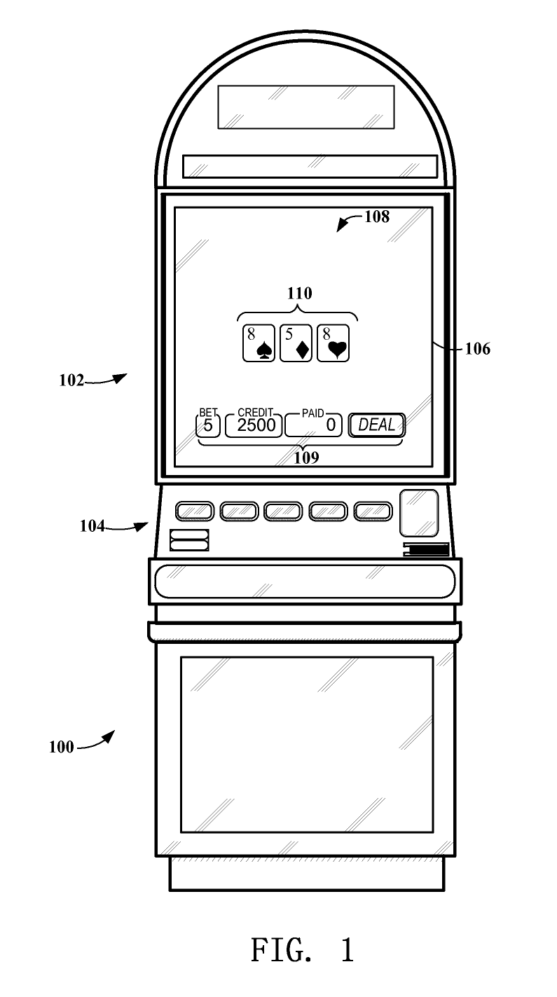

A representative embodiment for using multi-positional game elements is shown in FIG. 1. Referring to the example gaming apparatus 100 shown in FIG. 1, the gaming apparatus includes a display portion 102 (also referred to as a gaming display), and a player interface portion 104, although some or all of the user interface 104 may be provided via the display 102 in touch screen embodiments. The display portion 102 may include one or more display areas 106 that may be included in physically separate displays or as portions of a common large display. Here, the game display 106 includes a game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are known in the art. For example, coin/symbol input mechanisms, card readers, credit card readers, smart card readers, punch card readers, radio frequency identifier (RFID) readers, and other mechanisms may be used to enter wagers. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The display device 102 may include one or more of an electronic display, a mechanical display, and a fixed display information, such as paytable information associated with a glass/plastic panel on the gaming machine 100. The symbols or other indicia associated with the play of the game may be presented on an electronic display device or on mechanical devices associated with a mechanical display. Generally, the display 102 devotes the largest portion of viewable area to the primary gaming portion 106. The gaming portion 106 is generally where the visual feedback for any selected game is provided to the user. The gaming portion 106 may render graphical objects such as cards, slot reels, dice, animated characters, multi-positional game elements, and any other gaming visual known in the art. The gaming portion 106 also typically informs players of the outcome of any particular event, including whether the event resulted in a win or loss.

In some the example embodiments illustrated herein, the gaming portion 106 may display one or more multi-positional game elements 110 for use in a gaming event. Each of the multi-positional game elements 110 may include two or more positions that are assigned symbols for use in a gaming event. For example, in the illustrated gaming portion 106 shown in FIG. 1, three six-sided cubes 110 are shown as the multi-positional game elements. Here, each cube 110 includes a representative card suit and value. Thus, in this embodiment, 18 different “playing cards” are mapped to the three multi-positional game elements 110. In other embodiments, less than the total number of positions may be assigned symbols, such as card values/card suits.

When the cards are mapped to the multi-positional game elements according to one or more rules, the probability that certain card combinations occur can be influenced by the rules or selection process. In this example, the 18 cards selected and mapped can be done according to rules that encourage pairs, flushes, straights, or other card combinations. Thus, while 18 of the 52 cards (or whatever size deck is being used) are selected, each card may not have a corresponding probability of being selected as if the selection process was completely random. Since the multi-positional elements are 6-sided in this embodiment, each face of each of the dice or elements has a 1 in 6 chance of being shown as part of a game outcome. However, this two-step process of mapping the cards to the dice, and then rolling the dice does not necessarily give the same odds of having three “cards” appear as an outcome, as randomly selecting three cards in a deck to display as a hand or game outcome. This two-step process may thus be advantageous in encouraging or weighting specific types of outcomes as compared to conventional poker games.

Returning again to this illustrated embodiment, the three cubes 110, or dice, are manipulated or rolled to show an outcome of three “cards,” which are represented by the face-up sides of the three cubes. These three “cards” are then evaluated relative to a paytable to determine prizes or awards. The illustration and description of this poker embodiment is for purposes of example and not of limitation; the present invention may be applicable to numerous other poker games, as well as other types of gaming activities and apparatuses, using a variety of symbols or indicia on the multi-positional game elements 110.

The gaming portion 106 may include other features known in the art that facilitate gaming, such as status and control portion 109. As is generally known in the art, this portion 109 provides information about current bets, current wins, remaining credits, etc. associated with gaming activities of the game play area 108. The control portion 109 may also provide touchscreen controls for facilitating game play. The game play area 108 may also include touchscreen features, such as facilitating selection of individual game elements for holding, rolling, or otherwise selecting or manipulating. The gaming portion 106 of the display 102 may include other features that are not shown, such as paytables, navigation controls, etc.

Embodiments of the present concept also include mapping multiple possible game symbols or indicia to the one or more multi-positional game elements for use in a gaming event. In one embodiment, this procedure includes mapping playing cards to a virtual dice and allowing player to roll the dice to achieve poker hands that pay based on a paytable. In other embodiments, this procedure could include mapping other symbol sets, numerical values, etc. to dice, or other multi-positional game element.

Although six-sided cubes or virtual dice are shown in FIG. 1, any shaped multi-positional game element could be utilized. For example, a two-sided “coin” may be used in some embodiments. In other embodiments, a four-sided pyramid, a ten-sided game element, etc. could be used. The multi-positional game elements could be used in determining outcomes in a primary or base game, in determining bonus modifiers for use with the primary game outcomes, or in determining outcomes in a separate bonus game.

In some embodiments, each side of the multi-positional game element or dice may be assigned a symbol, which in other embodiments, only some of the sides or positions of the multi-positional game elements (such as the visible sides, or sides not associated with mystery outcomes) may be initially assigned symbols. In embodiments that utilize multi-positional game elements similar to dice, the dice could be typically-shaped six-sided dice, could be any other number of sided-dice. In addition, there may be 1−x number of dice used. For embodiments using “cards” as symbols in the different positions of the multi-positional game elements, the game indicia symbols being mapped to the game elements could include a standard deck of playing cards, which may or may not include jokers, or they could be a non-standard deck. In other embodiments, the symbols could be assigned from multiple decks of cards, or be assigned from a combination of cards and other symbols.

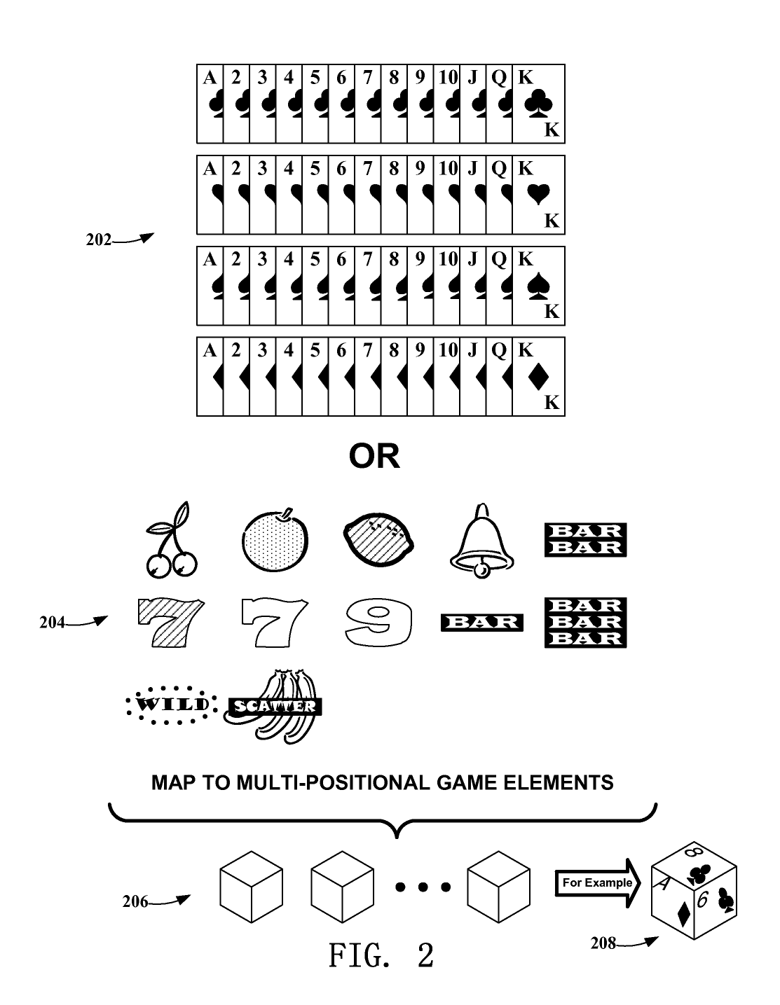

For example, as shown in FIG. 2, a deck of cards 202, slot-type symbols 204, or any other type of symbols are mapped to multi-positional game elements 206 to generate, for example, dice 208 with cards suits/values shown on each side or face. Although playing cards or slot symbols are shown in FIG. 2, various other symbols or indicia, such as multiplier values, credit values, blank images, or other types of symbols may be used and/or mapped to the multi-positional game elements 206.

In other embodiments, multiple cards may be shown on some or all of the faces of the multi-positional game elements. Each of the cards on a multi-card face (split-card symbol) may be used to form a game outcome, or the card that helps form the optimum hand with the other dice outcomes may be used. The split cards may be two of the same cards, or different cards. In one example, three 6-sided dice may be rolled to form a game outcome where one of the dice has two card (split cards) on each face of the die. After the dice all stop rolling, the best three card hand of the four shown cards may be used as an outcome. In another example, multiple symbols may appear on some or all sides of multi-positional game element used with a slot game where each symbol of the multi-symbol element may be shown as an independent symbol when evaluating and/or showing game outcomes.

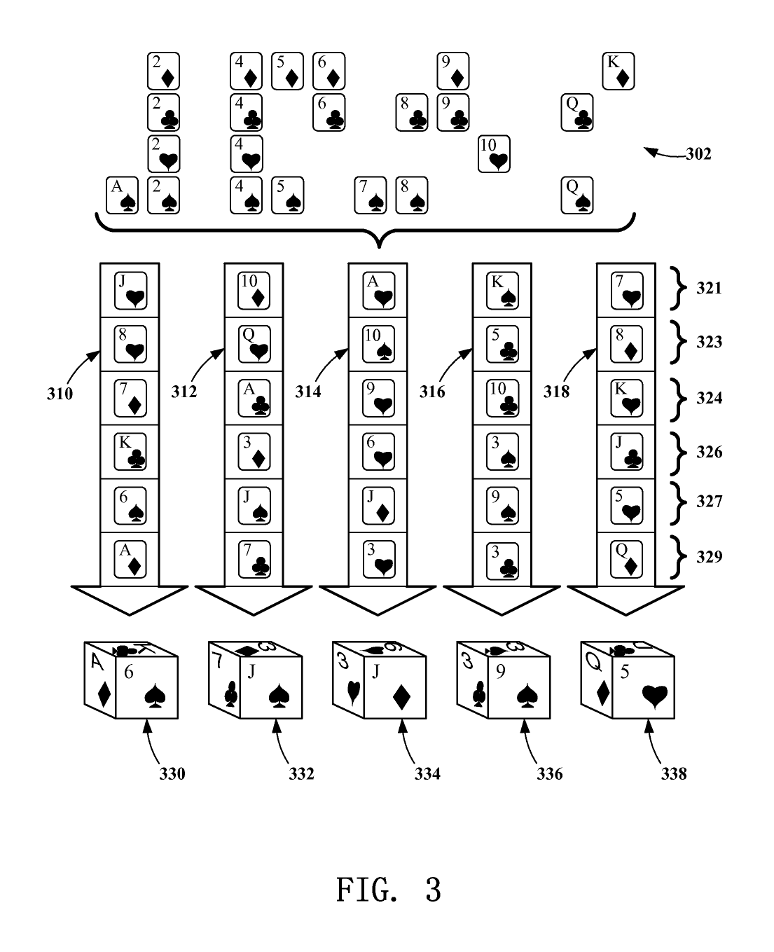

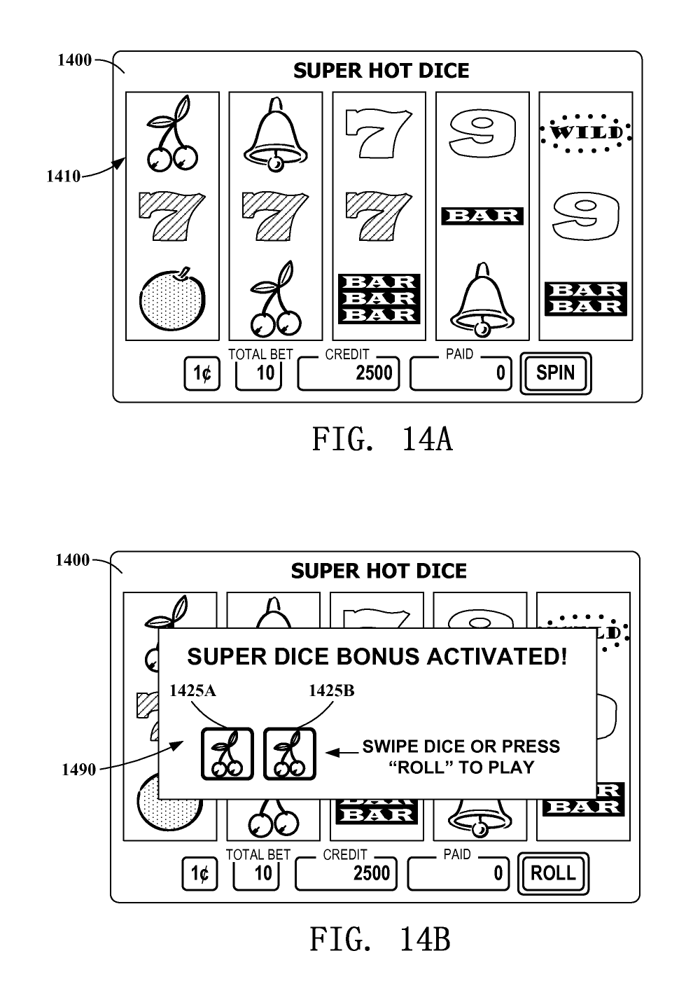

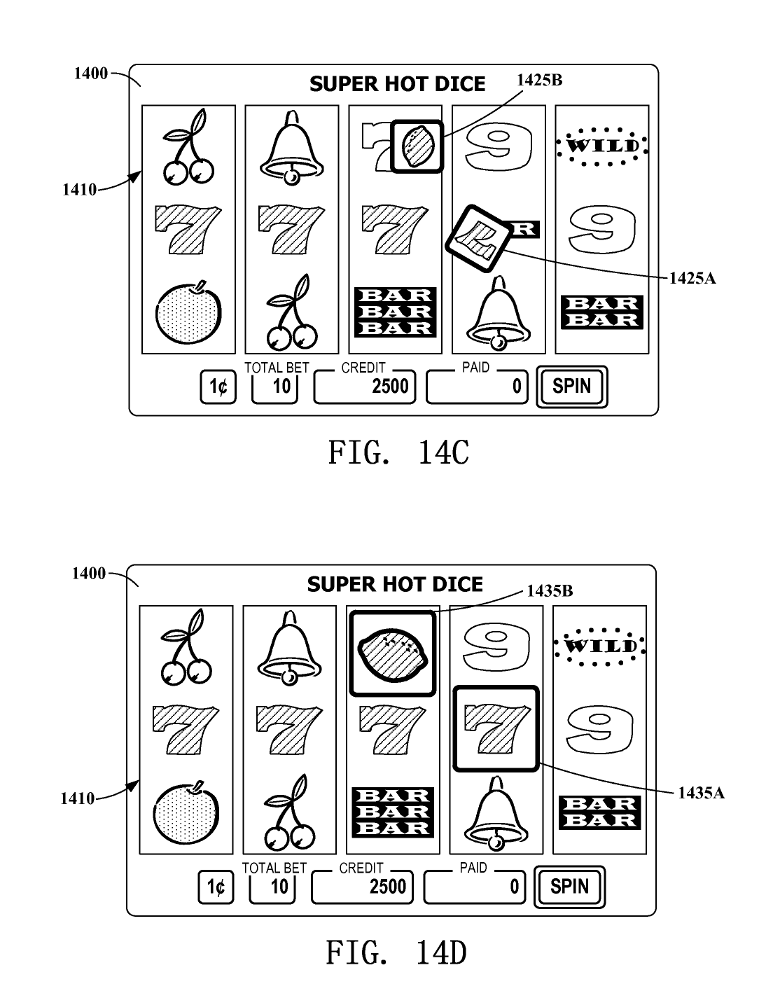

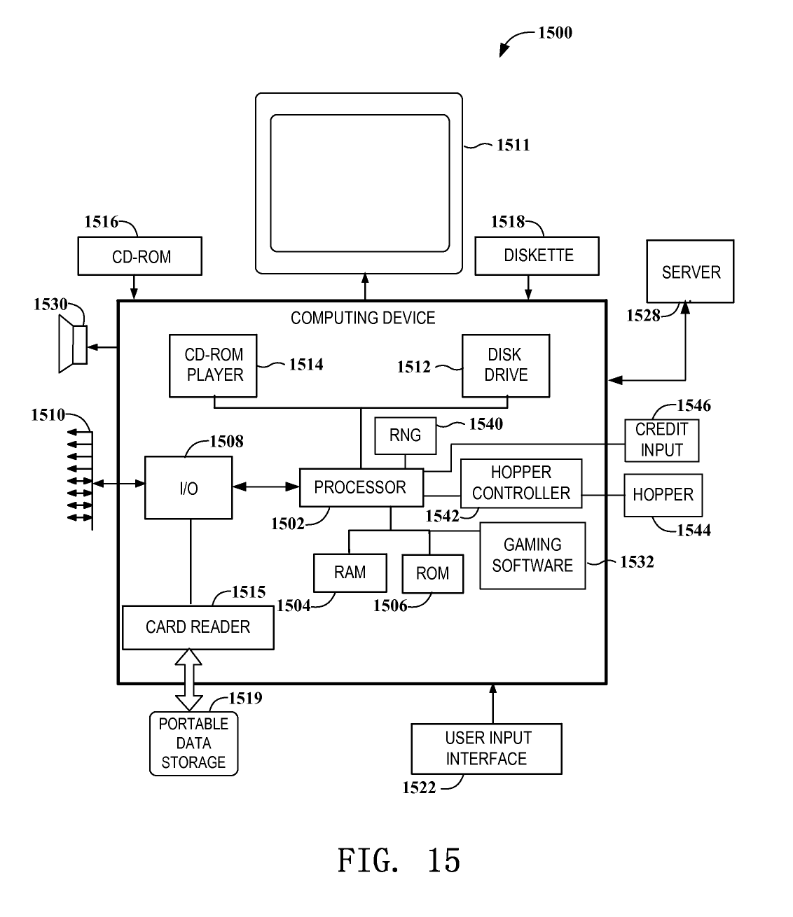

FIG. 3 illustrates a more specific embodiment, where five six-sided dice 330, 332, 334, 336, 338 are each assigned card symbols (suits and values) from a standard 52 card deck 302. Here, since there are five multi-positional game elements 330-338, each with six sides, a total of 30 cards (the 6 sides of each dice×5=30 cards) would be selected from the deck 302. To select and assign the cards for each game element 330-338, a game processor (see e.g., 1402 in FIG. 14) may randomly draw six cards 310 for use with each position 321, 323, 324, 326, 327, 329 of the first game element 330, randomly draw six cards 312 for use with each position 321, 323, 324, 326, 327, 329 of the second game element 332, randomly draw six cards 314 for use with each position 321, 323, 324, 326, 327, 329 of the third game element 334, randomly draw six cards 316 for use with each position 321, 323, 324, 326, 327, 329 of the fourth game element 336, and randomly draw six cards 318 for use with each position 321, 323, 324, 326, 327, 329 of the fifth game element 338. In these embodiments, each card may only be selected once. However, in other embodiments, cards or other symbols may be repeatedly selected, or multiple decks could be used to generate the selections, which could potentially allow multiple similar symbols to appear together in a gaming event outcome. For example, ten or more dice may be used and some of the card symbols may appear in multiple positions on the dice. Hence, in these embodiments, it may be possible to receive, for example, two King-Spades. In other embodiments, it may also be possible to receive duplicate card values if less than 10 dice are used in the game. In some embodiments, all the cards may be selected prior to assigning them to the dice. In other embodiments, each side of each die would be randomly assigned a card.

In other embodiments, however, the cards 310, 312, 314, 316, 318 are selected from the deck 302 according to one or more predefined rules. These predefined rules for assigning card symbols to the dice may allow for or encourage specific hand types. For example, rule sets could include placing cards that have same numerical value on different dice first, placing different suits high card to low card on different dice, or placing similar non-adjacent suited cards on the same die until all cards and have been assigned. There could be many different types of rules to assign cards to dice faces, or the assignment could be entirely random after the 30 (or other number) of cards is selected based on one or more rules.

In one example, the rules for assigning cards to three six-positioned multi-positional game elements (referred to as dice) includes:

1) Randomly select a card; assign selected to card to first die.

2) Select two of the three other card values having the same card value as the card selected in Rule 1; assign one of the selected card values to the second die, and the other to the third die.

3) Determine if the card value of randomly selected card in Rule 1 is a high card (10 or higher); if not randomly select 6 high card values for all card values and assign two to each die; if the Rule 1 card is a high card, randomly select 3 high card values and assign one each to each die.

4) Determine if any doubles were selected in Rule 3; randomly select one to three additional cards and a similar valued cards to create at least three pairs of doubles; assign each double pair to different dice.

5) Randomly select low cards to fill in the remaining open positions on the dice.

Although the above set of rules covers specific examples of assigning card values to allow for a three-of-a-kind; pair, or high card outcome, various other rule sets may be used to emphasize or restrict certain outcomes. In addition, rules may only loosely help in assigning card values to the multi-positional game elements. For example, a single rule may be used that specifies that similar card values cannot appear on the same die.

In other embodiments when mapping the cards (symbols, etc.) to dice, a weighted table can be used to change the odds of particular cards being selected to be mapped to the dice. In these embodiments, each card would not necessarily have a 30 out 52 chance (for example) of being selected for the dice. As discussed above, the two-step selection process of generating game outcomes can be advantageous over conventional methods to encourage certain outcomes. Here, the first step of selecting cards (or symbols) to appear on the dice or multi-positional game elements can be done according to rules to influence what combinations are possible or likely in outcomes after the second step when the dice are rolled to randomly display one face or side that shows a card or symbol indicia.

Returning to the embodiment of 5 dice shown in FIG. 3, after a gaming device assigns each selected card to a dice side, and the five dice may be rolled to generate a game outcome that is associated with a poker hand. Here, after the dice are rolled, the game machine would determine whether the player would be awarded any prizes, such as credits, multipliers, free games, etc.) according to a paytable. Alternatively, if a first roll result met predefined criteria the player may continue to roll the dice again, and potentially continue to roll as long as the results met the predefined criteria. The predefined criteria may include a maximum number of rolls or specify different rules depending on how many rolls had been awarded. These embodiments are discussed in more detail below.

This concept may be applied to any games with dice, any types of poker games, or any other type of slot game. For example, some embodiments could use many different numbers of dice, where, for instance a player may be able to roll 7 dice, and get best 5 card poker hand. Alternatively, a player may roll 3 dice and be awarded prizes based on a 3 card paytable.

In other embodiments, a player may be allowed to have multiple rolls to build multiple hands. For example, a player may roll 3 dice, then roll 4 dice, and then roll 5 dice and be paid according to three different paytables for each set of rolled dice (i.e., the 3 dice hand would be evaluated using a 3 card paytable, the 4 dice hand would be evaluated using a 4 card paytable, and the 5 dice hand would be evaluated using a 5 card paytable). Alternatively, a player may roll 2 dice, then roll 2 more dice, and then roll a single die and be paid based on a 5 card poker table, or even roll 2 dice, roll another 2 dice, and then roll a final 2 dice, where the best 5 cards from the 6 dice are evaluated using a 5 card paytable.

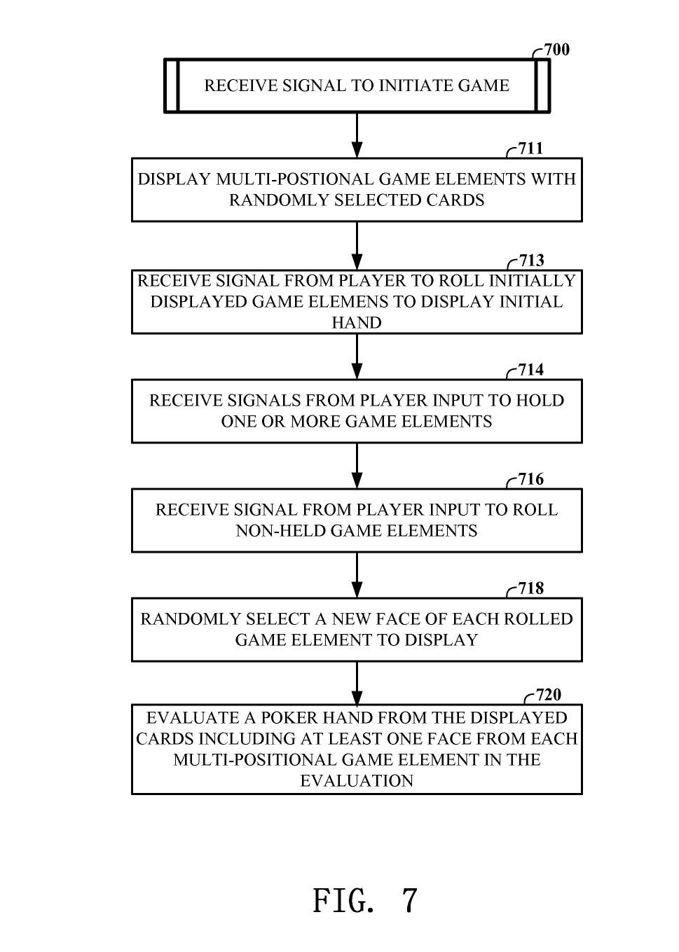

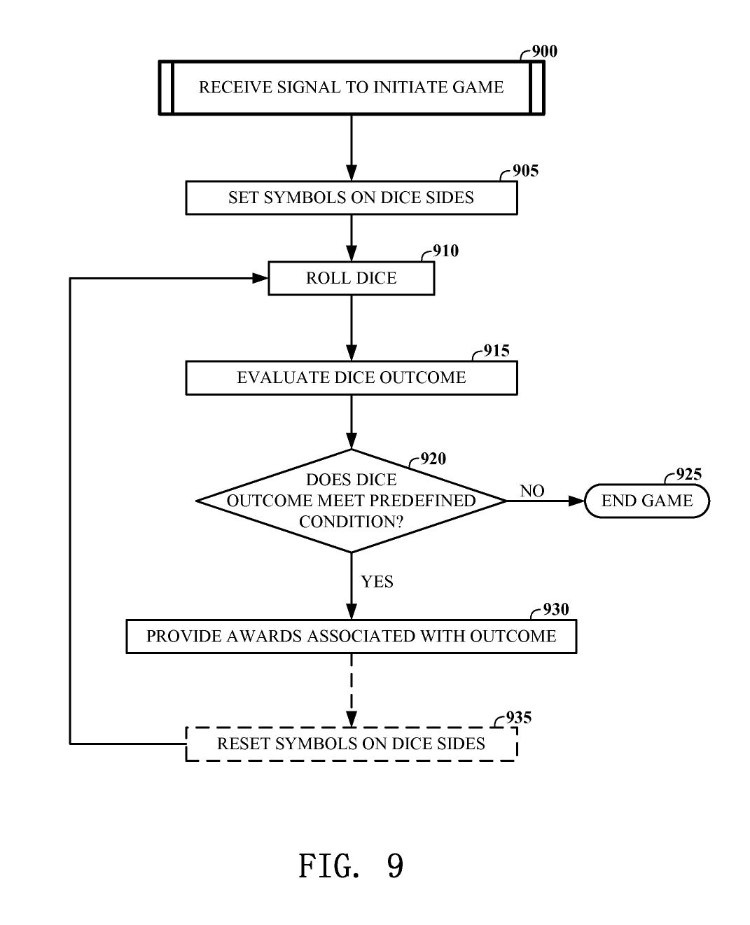

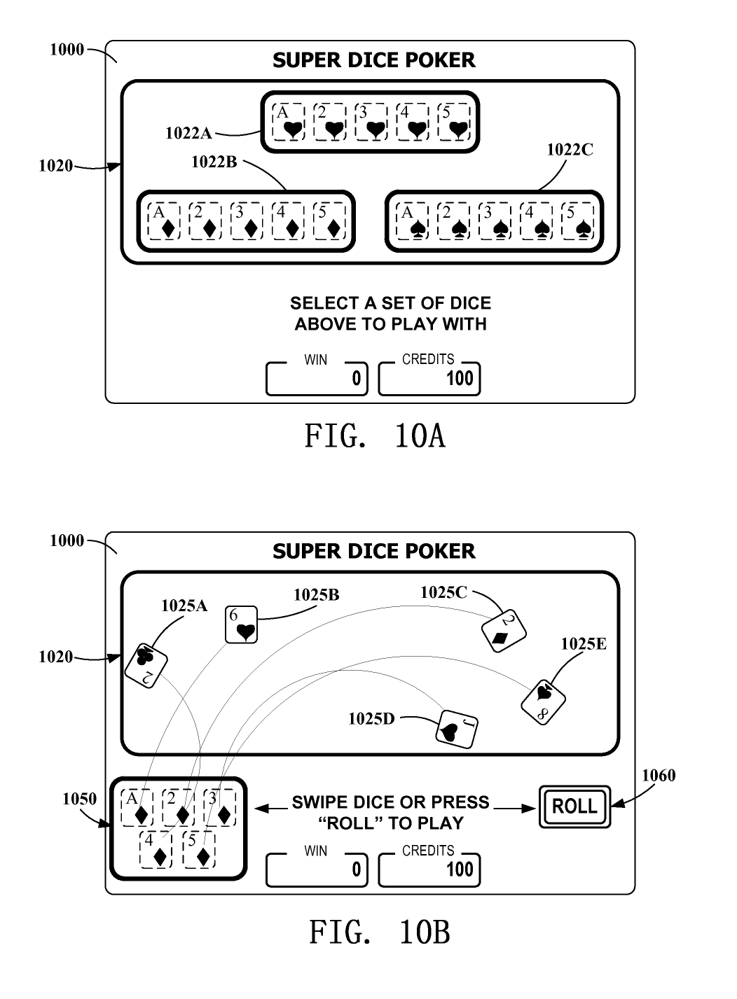

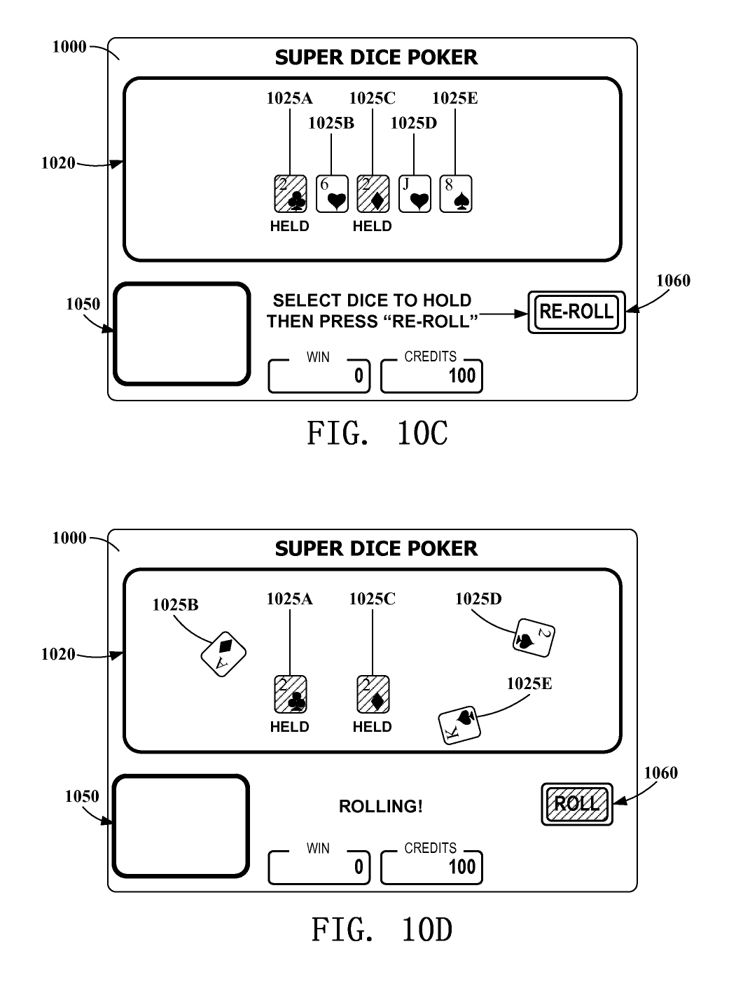

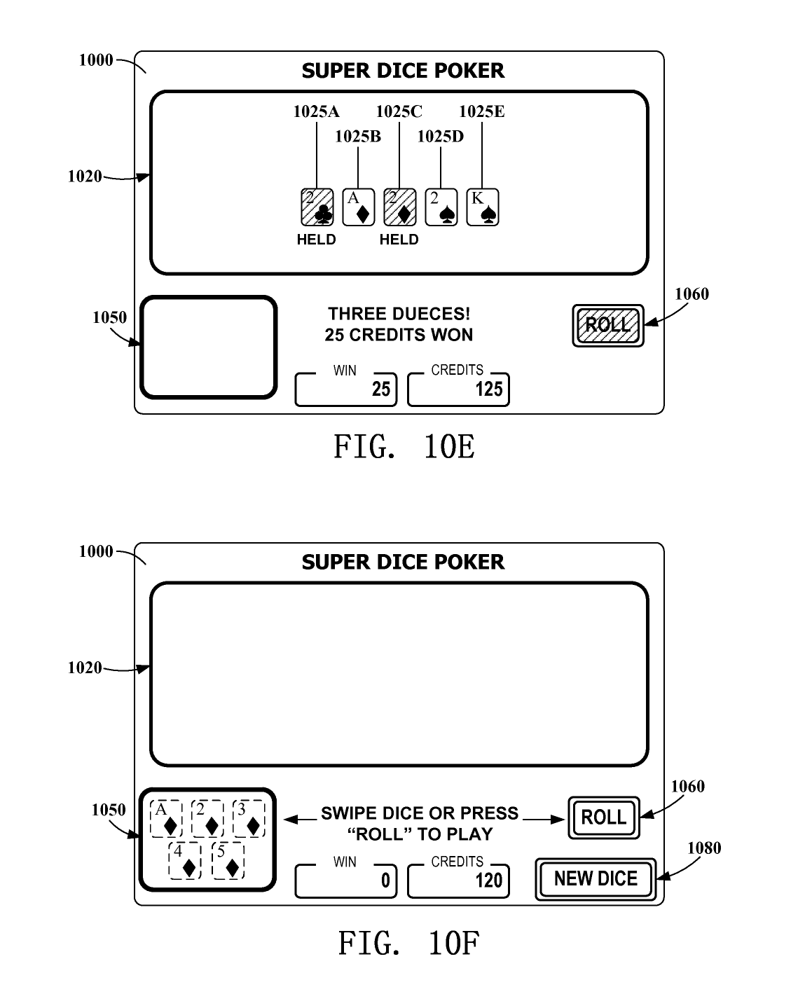

In other embodiments, a game could include rolling 5 dice, allowing the player to hold the dice they want, and then re-roll the unheld dice. These embodiments may be similar to draw poker, and is discussed below with respect to FIGS. 7 and 10A-10F. In some of these embodiments a game processer re-selects cards for the other (non-shown) faces of the dice prior to the re-roll so that when you draw every possible card combination is still available. In other embodiments, the unheld dice are re-rolled and only the originally mapped values for each die are possible outcomes on the re-roll.

In some embodiments, one or more of the other sides of the dice not used in the initial evaluation (e.g. not the front face of the dice) can be shown (see FIG. 3) so that the player has at least some information of what the other possible symbols are on each dice. In some embodiments, the player may be able to manipulate the dice to see some or all of the other symbols on the dice.

Once cards have been assigned to sides of dice, player could view all sides of dice to see what cards are available, or could be setup where the player can't view any of the dice sides except the front one. In some embodiments, the player may be able to select a face of one or more dice, or nudge a die over to display a different side of the die. The ability to select or nudge one or more dice may require a side bet or additional wager. In some embodiments, a player may be able to rotate or nudge a die, but not control what other side the die is then shown as an outcome (face up).

In some embodiments, the player may be shown the best scoring outcome possible on the dice prior to rolling the dice. In other embodiments, the player may not be shown any symbols appearing on the dice prior to rolling the dice (e.g., the dice may have a blank symbol initially, a question mark symbol, or otherwise not display a possible outcome on the face of the dice prior to the dice being rolled. In various other embodiments, the player may be shown what the best possible outcome was after the dice have been rolled and evaluated. Here, the best possible outcome may be displayed away from the game area of the screen so that the player does not mistake the later shown best possible outcome for the actual game outcome for which prizes are evaluated.

As discussed above, the possible game indicia symbols may not include a complete deck of cards, may include extra cards such as wild cards or special cards, or may not include cards at all. For example, symbols from a slot game may be mapped to the multi-positional game elements, where the resulting outcome of symbols is evaluated from a symbol paytable.

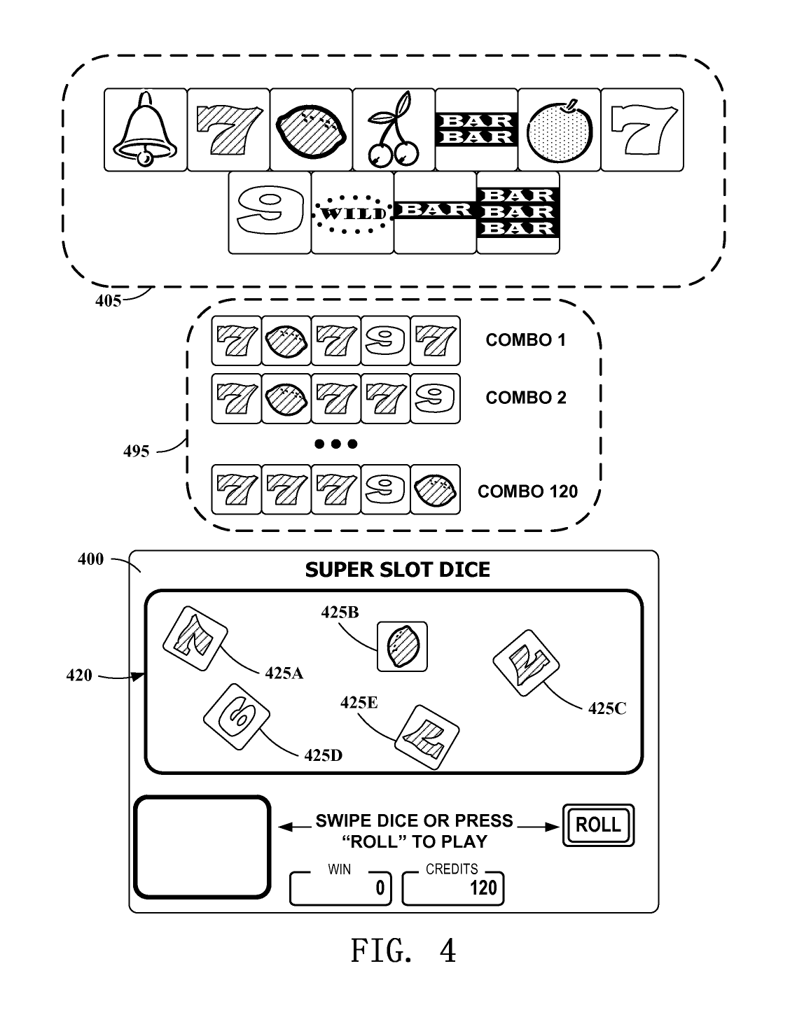

For example, FIG. 4 illustrates a game display 400 having a game play area 420 where five six-sided multi-positional game elements 425A, 425B, 425C, 425D, 4525E having slot symbols are thrown, rolled, or manipulated. As shown in FIG. 4, the “slot dice” may include any of the shown slot symbols in area 405. These symbols may be randomly assigned to each side of the multi-positional game elements. This assignment may be completely random, or may be done in association with a weighted table so that high level symbols (such as the “Wild” symbol) do not appear as often as a lower symbol. Once the multi-positional game elements 425A-425E have been activated and come to rest to show an outcome, a game processor may determine one or more symbol combinations or permutations 495 to arrange the symbols to see if a winning combination of values is present. That is, in some embodiments wins are simply calculated by the number of symbols that appear on the screen regardless of order. In the example shown in FIG. 4, three shaded 7s 425A, 425C, 425E have appeared as a result in the game play area 420. Here, the processor would simply count the number of symbols present for each multi-positional game element 425A-425E, and award prizes based off this count. This would work in a similar manner to how “scatter” symbols are counted in conventional games. Thus, the three shaded 7s may be associated with a pay in a paytable, while the single “9” and “lemon” may not be associated with any prizes.

In other embodiments, the ordering of the symbols may matter. Here, the processor may determine each permutation 495 of the symbols to determine prizes. Here, only the highest paying permutation may be paid (three shaded 7's), or each permutation including a winning outcome may be paid (i.e., each permutation where the three shaded 7's are in the leftmost three positions). These methods may also work with combinations or hybrid combination/permutations where only different symbols are rearranged and counted as a separate ordered outcome. These methods may also be used when more multi-positional game elements are thrown than can be used in an outcome combination. For example, eight multi-positional game elements may be rolled, but only five may be used for an outcome combination. Here, the game processor may go through each combination (eight choose five), or permutation to determine awards.

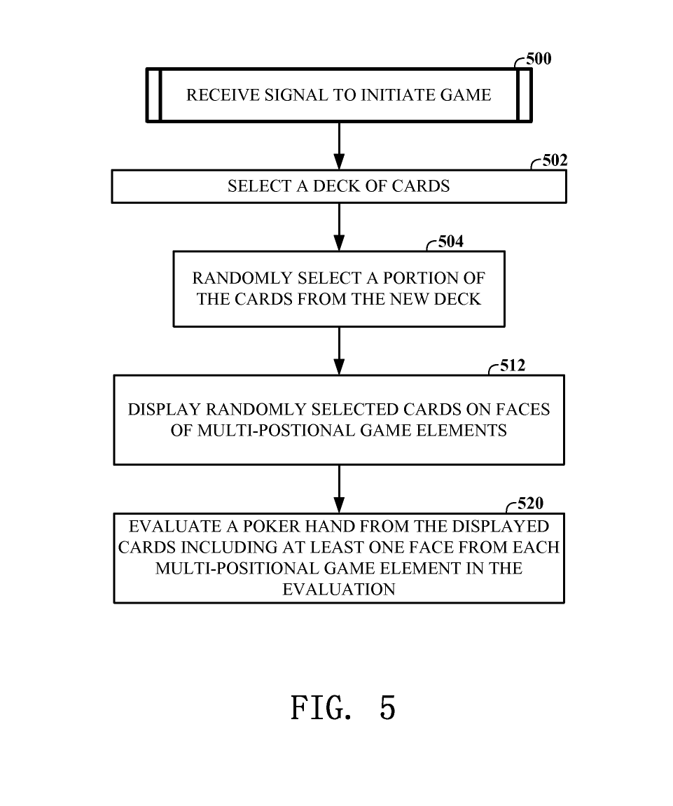

FIG. 5 is a flow diagram illustrating a method of mapping poker card values to one or more multi-positional game elements according to embodiments of the invention. Although various processes are shown in a particular order in this flow diagram, the order of these processes can be changed in other embodiments without deviating from the scope or spirit of this concept. Hence, the order of the processes shown is for illustrative purposes only and is not meant to be restrictive. Additional game processes may also be included between various processes even though they are not shown in these flow diagrams for clarity purposes. Further each of the processes may be performed by components in a single game device, such as by a game processor, or may be performed in part or whole by a remote server or processor connected to the gaming device via a network. Each process may be encoded in instructions that are stored in a memory, a computer-readable medium, or another type of storage device.

Note that this example method is just one embodiment of how a game operation can be implemented. As discussed and shown above, many variations exist which may require additional, less, or different processes to complete.

Referring to FIG. 5, the method includes receiving a signal to initiate a game 500, selecting a deck of cards 502, randomly selecting a portion of the cards from the deck 504, displaying the randomly selected cards on faces of the multi-positional game elements 512, and evaluating a poker hand from the displayed cards including at least one face form each multi-positional game element in the evaluation 520. The process of displaying the randomly selected cares on faces of the multi-positional game elements 512 may include initially displaying the multi-positional game elements as cubical dice and then allowing the player to roll the initially displayed dice prior to evaluating the poker hand from the displayed cards.

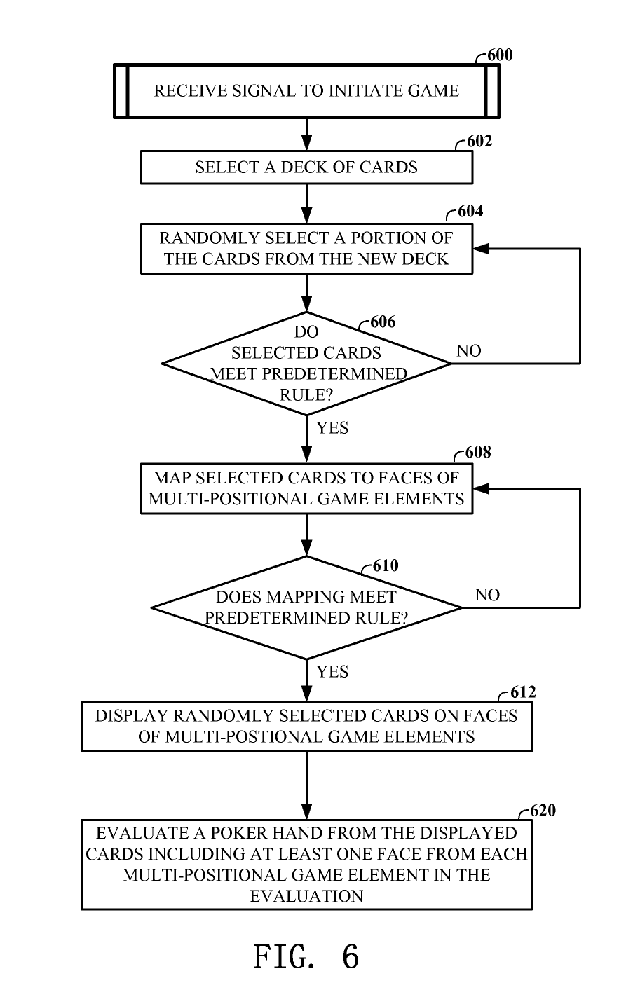

FIGS. 6 and 7 are flow diagrams that illustrate other embodiments that respectively include using rules to determine the selected or assigned cards shown on the multi-positional game elements, and an example game operation that include allowing the player to hold and re-roll at least some of the multi-positional game elements.

Referring to FIG. 6, a flow begins at process 600 where a signal to initiate a game is received. A deck of cards is selected in process 602 and a portion of the cards from the deck is randomly selected in process 604. Here, the number of cards selected corresponds to a number of available positions on one or more multi-positional game elements. In process 606 it is determined if the selected cards meet a predetermined rule. If they do not meet the rule, the flow returns to process 604 where one or more of the cards is reselected until they all meet the predetermined rule in process 606. Once it is determined that all of the selected cards meet the predetermined rule in process 606, the flow proceeds to process 608 where the selected cards are mapped to faces or sides of one or more multi-positional game elements. It is then determined if the mapping meets a predetermined rule in process 610. If the mapping does not satisfy the predetermined rule, one or more of the selected cards is re-mapped within the multi-positional game elements. In some embodiments, more cards may be selected in process 604 than are needed for the faces of the multi-positional game elements so that if the mapping of process 608 does not the predetermined rule in process 610, substitute cards can be used in the re-mapping rather than reorganizing the previously mapped cards.

When it is determined that the mapped cards meets the predetermined rule in process 610, the flow proceeds to process 612 where the selected cards are displayed on the faces of the multi-positional game elements. A poker hand is then evaluated from the displayed cards from at least one face of each multi-positional game element. In other embodiments, only some of the multi-positional game elements may be used in formulating a resulting poker hand. For example, if seven multi-positional game elements were used in a gaming event, the best five card poker hand may be evaluated from the seven cards displayed on the seven multi-positional game elements.

Referring to FIG. 7, an example method of playing a poker game using multi-positional game elements is shown. This method is shown by the flow that begins at process 700 where a signal to initiate a game is received. In process 711, one or more multi-positional game elements is displayed with randomly selected card symbols on each side or face of the game element. A signal is received in process 713 from a player to roll the initially displayed multi-positional game elements or “dice” to display an initial poker hand. In process 714 signals may be received from a player to hold none, one, or more of the game elements. The flow then proceeds to process 716 where a signal is received from the player to re-roll the non-held game elements. If all of the game elements have been held in process 714, none of the game elements would be re-rolled in process 716. In process 718, a new face of each re-rolled game element is selected to be displayed. After displaying this new poker hand, the flow proceeds to process 720 where a poker hand is evaluated from the displayed cards including at least one face from each of the multi-positional game elements.

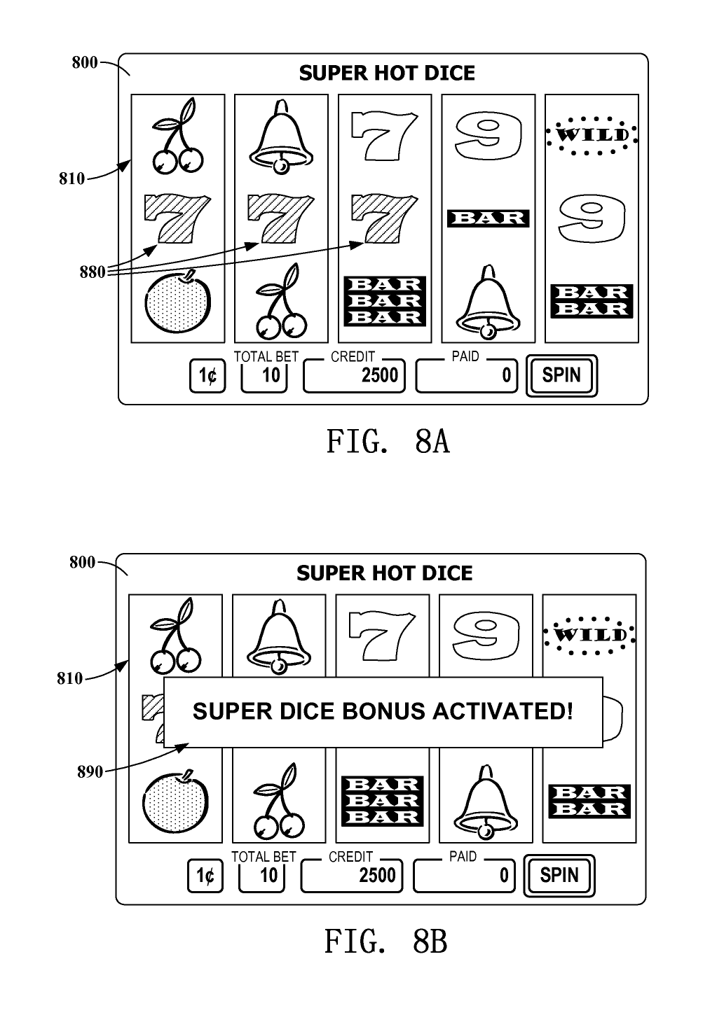

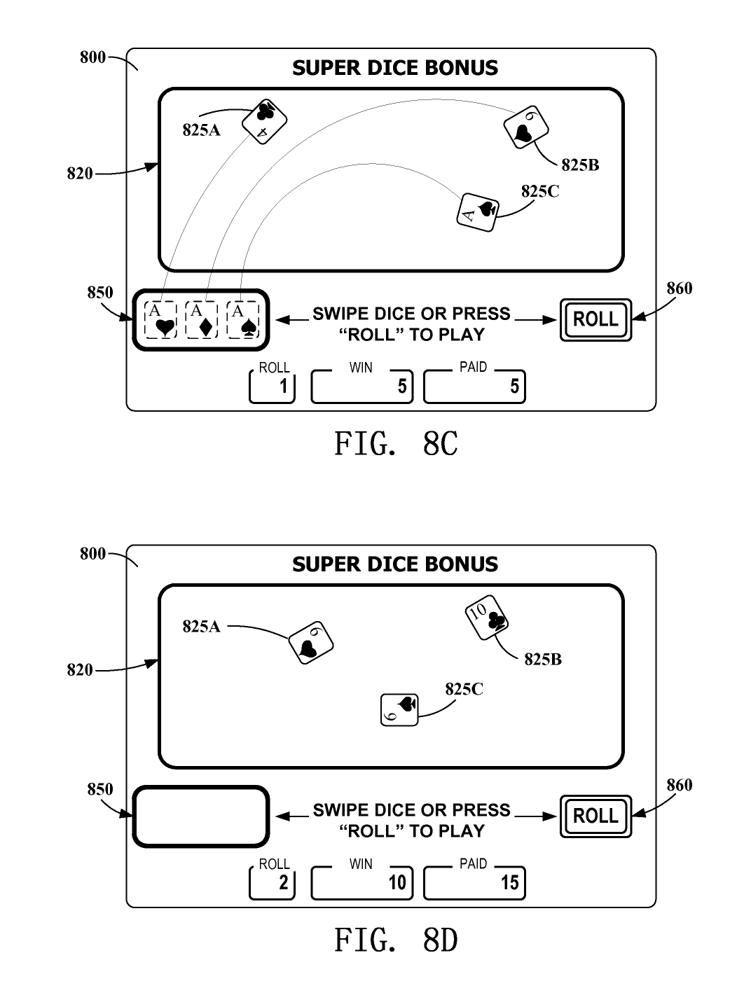

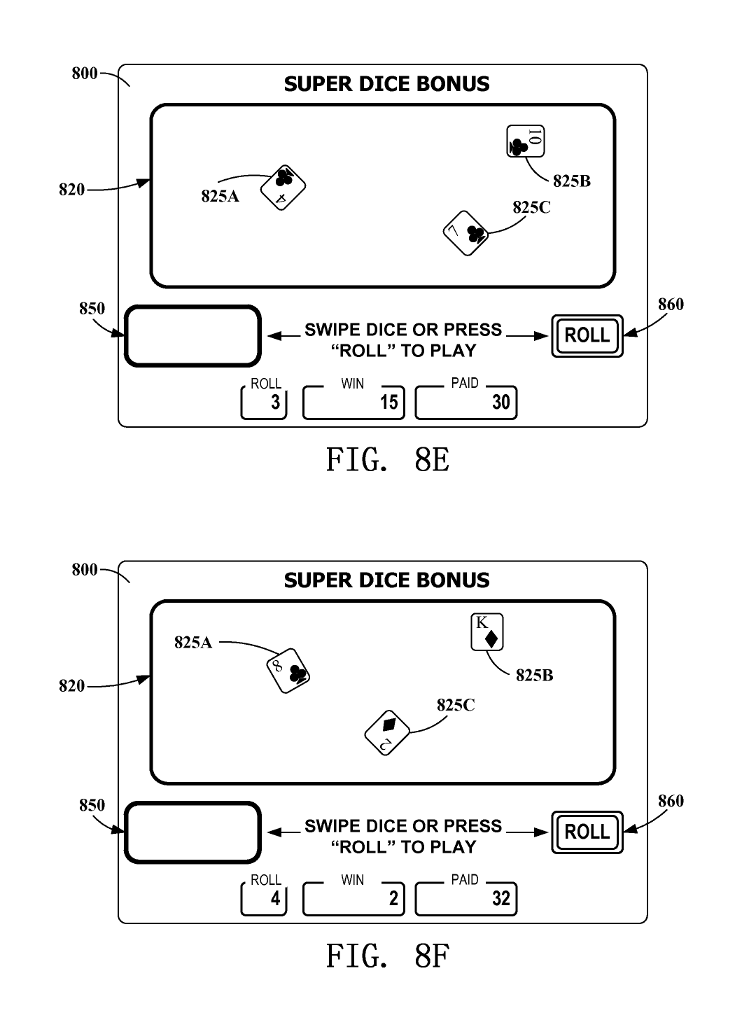

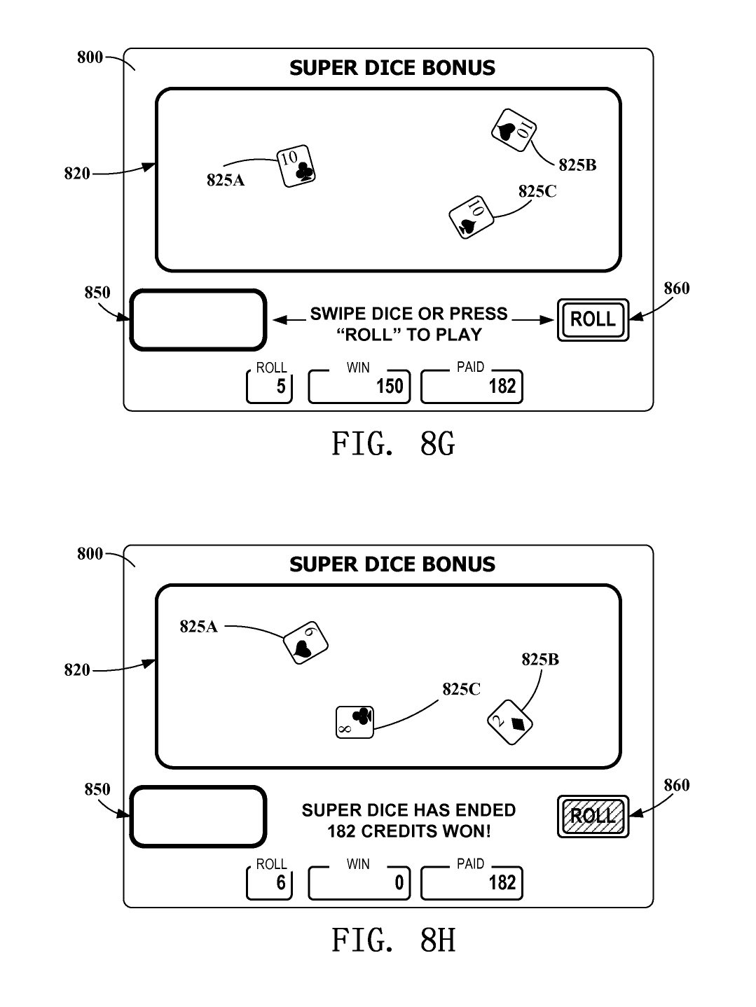

Although the above three flow diagrams show some embodiments of the invention, many different methods and/or processes may be used to map symbols to sides of one or more multi-positional game elements, or to utilize the game elements in game events. FIGS. 8A-8H illustrate one such example game progression of gaming events using multi-positional game elements.

Referring to FIGS. 8A-8H, a game display 800 includes a game play area 810 including five slot reels. These reels 810 may be spun or otherwise manipulated to generate a game outcome. In this particular embodiment, a bonus is triggered when three or more shaded “7” symbols 880 are received on a played payline. As shown in FIG. 8A, three shaded “7” symbols 880 have been received, thereby triggering the super dice bonus as shown by the dialogue or message box 890 in FIG. 8B. Here, the bonus includes mapping playing cards from a deck of cards to three six-sided multi-positional game elements (referred to as “dice”), rolling the dice, awarding prizes if the dice outcome includes a poker hand having an associated award in a paytable, and continuing to roll the dice until a terminating condition is reached.

As shown in FIG. 8C, a roll box 850 is provided with the initially displayed dice. The player may use his or her finger to touch and swipe the dice from the roll box 850 to activate them, or press the roll button 860 (or pull a game handle). In some embodiments, the gaming device may automatically roll the dice. This automatic roll may occur after a predetermined amount of time has elapsed or may be an selectable option available to the player. When the dice are swiped, rolled, or otherwise activated, they are randomly moved and rolled in the roll area 820 of the game display 800. As shown in FIG. 8C, the first die 825A has come to a rest with a 4-Clubs shown, the second die 825B has come to a rest with a 6-Hearts shown, and the third die 825C has come to a rest with an Ace-Spades shown. Here, a high card of an Ace is associated with an award of 5 credits. Further, as a winning outcome is present, the player is allowed to continue rolling the dice. That is, the bonus is terminated when a winning poker hand is not received during a roll.

During the second roll of the bonus, shown in FIG. 8D, the player receives a pair of 6s, which has an associated award of 10 credits. Again, since the second roll has resulted in a winning poker hand, the bonus continues to a third roll. The third roll is shown in FIG. 8E where has received a club flush and a high card 10. As only the highest paying poker hand is awarded, the player receives 15 credits for the flush (as opposed to, or in addition to, the 2 credit win associated with the high card 10). In FIG. 8F, the fourth roll is shown, which results in a high card King and an associated award of 2 credits. In FIG. 8G, a fifth roll has resulted in a three-of-a-kind with three 10s. The associated award of 150 credits is added to the total bonus award, and play proceeds to the sixth roll. The sixth roll, as shown in FIG. 8H, does not result in a winning poker hand. As mentioned above, receiving a losing poker hand is a bonus-terminating condition that ends the current bonus and returns play to the base slot game shown in FIG. 8A, although the player does receive the 182 credits won during the bonus.

FIG. 9 is a flow diagram of method of operating a gaming device according to embodiments of the invention. These methods include the above example discussed with respect to FIGS. 8A-8H, as well as various other embodiments. Referring to FIG. 9, a flow begins at process 900 where a signal is received to initiate a game. This could be the signal to initiate a base or primary game (e.g., such as in response to receiving a wager), or may be the signal to initiate a bonus game based on the outcome of a primary game or a random bonus-trigger determination. In process 905, symbols are set on the multi-positional game elements (referred to as “dice” for ease of understanding). This process may include any of the processes discussed above for mapping symbols to each side of the dice, or any other method of selecting or mapping symbols to positions on one or more multi-positional game elements.

The dice are rolled or otherwise manipulated so that one or more of the positions on the multi-positional game elements are displayed on a game display in process 910. The displayed positions of the dice are then evaluated in process 915. This evaluation process 915 may determine, for example, prizes or other awards associated with the outcome of the rolled dice. In process 920 it is determined if the displayed dice outcome meets a predefined condition. In the above example, the predefined condition was a determination of whether the displayed cards on the dice resulted in a winning poker hand. However, in other embodiments, other conditions may be used. For example, there may be a cap on the number of rolls a player receives in a bonus game, or at least one of the displayed cards must include a “red card” (i.e., a card with the suit of heart or diamond). In another example, one of the sides of the multi-positional game elements may be marked with a terminating mark (e.g., a sub-symbol on the card or other displayed symbol), where the bonus is terminated when the position with the terminating mark is displayed as an outcome. In embodiments where a predetermined or fixed number of rolls is given, a retrigger condition may be available to generate another number of rolls. For example, a specific outcome, such as a pair of cards in a poker embodiment, may retrigger another fixed number of rolls. In other embodiments, a combination of conditions could be used. For instance, a player may be given a fixed number of rolls to start with and then have to meet another condition, such as a minimum poker hand, to continue rolling after the initial fixed number of rolls is completed. Various other conditions may be used as well, that may or may not depend on the displayed outcomes on the one or more multi-positional game elements. Here, if the condition is not met in process 920, the game ends in process 925. If the condition is met in process 920, the flow continues to process 930 where awards associated with the dice outcome is provided. In embodiments where a winning outcome is not the condition used in process 920, process 930 may occur before prior to process 920 to ensure any awards due are provided to the player.

An optional process 935 may be included to reset the symbols on the dice sides. If this process is not included in an embodiment, the same dice with the same symbols is re-rolled in process 910. Alternatively, if process 935 is included, the dice rolled again in process 910 are new dice with new symbols, which may provide for an increased chance of getting a high paying combination, or an increased chance of receiving a losing game outcome.

FIGS. 10A-10F illustrate another example game progression according to embodiments of the invention. Referring to FIGS. 10A-10F, a game display 1000 includes a roll area (or game play area) 1020. In FIG. 10A, a player is initially offered multiple sets of dice 1022A, 1022B, 1022C from which to select. In some embodiments, the player may be able to examine or see each die in each set, while in other embodiments the player may not be shown any or most of the cards on the dice sets. Although not shown in the embodiment illustrated below, the non-selected dice sets may have an outcome shown to the player during game play to show them what they would have received had they selected a different set of dice. In some embodiments, the player may be able to buy or play all three sets of dice, which may play in a multi-hand poker type method or as independent poker hands.

Returning to FIG. 10A, the player has selected to play with the second set of dice 1022B. These selected dice are then placed in a roll box 1050, where the player may again touch and swipe the dice or press a roll button 1060 to activate the dice and roll them in the roll area 1020. Here the five dice 1025A, 1025B, 1025C, 1025D, 1025E are jumbled around the roll area 1020 and come to rest, as shown in FIG. 10B. As shown in FIG. 10C, the result of the first roll is shown and the dice are moved to a line for ease of examining the resulting poker hand. Here, the player may touch none, one, or more dice to “hold” or maintain them and re-roll any non-held dice for new values. The player may also use buttons on a player interface panel (not shown) to hold the dice 1025A-1025E. In this embodiment, the player has held the 2-Clubs 1025A and 2-Diamonds 1025C. The player then presses the re-roll button 1060 and the remaining dice 1025B, 1025D, 1025E are re-rolled. In this embodiment, new card values for each position of each of the non-held dice are re-selected. However, in other embodiments, the same values that were originally set on the non-held dice may be used again in the re-roll.

As shown in FIG. 10D, the non-held dice 1025B, 1025D, 1025E have been re-rolled. These re-rolled dice 1025B, 1025D, 1025E are aligned with the held dice 1025A, 1025C to form a final poker hand outcome, as shown in FIG. 10E. Here, an additional “2” was received in the re-roll, resulting in a three-or-a-kind and an associated award of 25 credits. In FIG. 10F, another game may wagered on and played using the same dice (although new values for each position of each die may be selected), or a new set of dice may be selected by using the new dice button 1080. The different sets of dice may be differently shaded, colored, or themed. Thus, a player may feel, for example, that a current set of red dice has run out of luck, and may select a new set of dice, that have a tropical theme. In other embodiments, a player may be able to upload or otherwise specify a dice theme to use in the game.

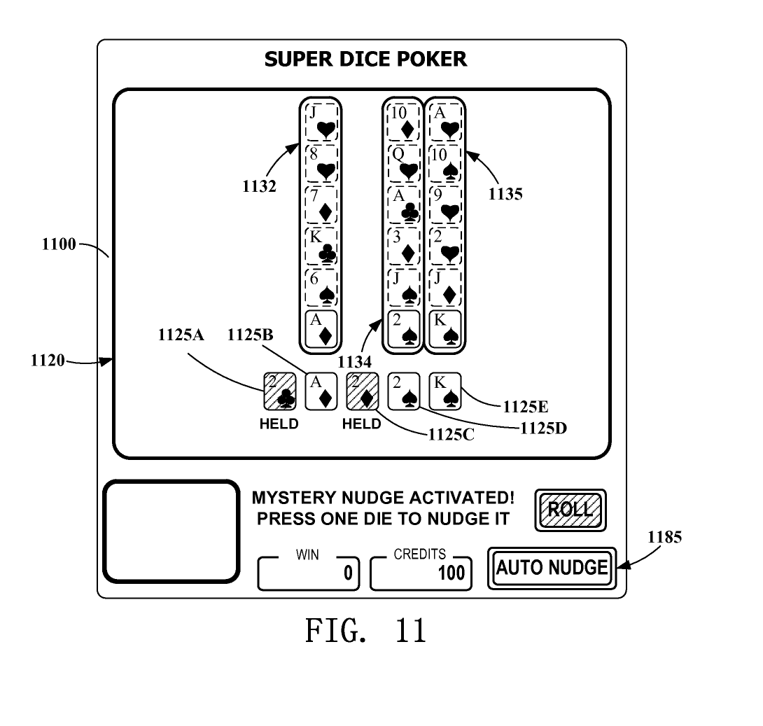

FIG. 11 is a diagram of a game display showing a gaming event having multi-position game elements according to embodiments of the invention. In particular, FIG. 11 shows another feature that can be used with embodiments of this concept. Referring to FIG. 11, a game display 100 includes a game play area 1120 that provides a gaming event using multi-positional game elements or dice 1125A, 1125B, 1125C, 1125D, 1125E in a similar manner to the one described above in FIGS. 10A-10F. However, this game includes a mystery nudge that occurs after a final dice poker hand is shown (such as the one shown in FIG. 10E). Here, a random determination is made as to whether the mystery nudge feature is triggered. When triggered, the non-held dice (or all of the dice is other embodiments) are associated with a card viewer 1132, 1134, 1135 that shows all of the possible cards on the different positions of those dice. Thus, in the example shown in FIG. 11, a first card viewer 1132 is associated with the second die 1125B, a second card viewer 1134 is associated with the fourth die 1125D, and a third card viewer 1135 is associated with the fifth die 1125E. Note that in other embodiments, five card viewers may be used if the held dice could be nudged.

Here, the player can press one of the non-held dice 1125B, 1125D, 1125E to nudge that die to a new position. The new position may be randomly chosen from the possible positions, or the player may be able to select a position that it is nudged to depending on the embodiment. In addition, an “auto nudge” button 1185 or auto nudge option may be provided to automatically determine which of the possible dice is best to nudge for the best chance at increasing a win. In the embodiment shown in FIG. 11, the player may want to select the fifth die 1125E to nudge, since this will provide a chance at receiving four “2s”. Many variations of this feature may appear in other embodiments, such as the nudge feature being triggered by the poker outcome rather than at random.

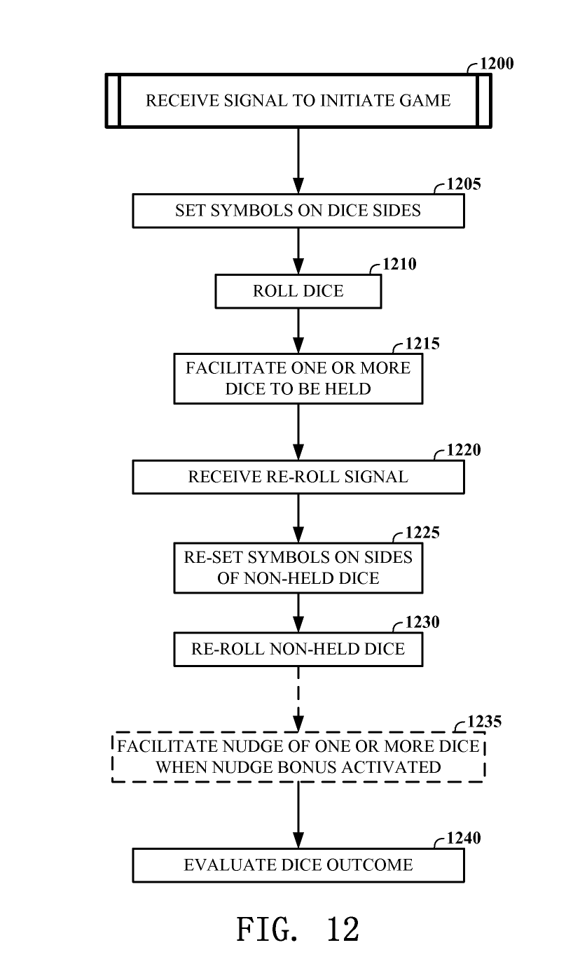

FIG. 12 is a flow diagram showing a method of operating a gaming device in a manner similar to that shown above in FIGS. 10A-10F and 11 according to embodiments of the invention. Here, the method includes receiving a signal to initiate a game 1200, setting symbols on the dice sides 1205, rolling the dice 1210, facilitating one or more dice to be held 1215, receiving a signal to re-roll any non-held dice 1220, re-setting symbols on sides of the non-held dice 1225 and re-rolling the non-held dice. The method may optionally include the nudge feature, which is shown in process 1235 where the method facilitates the nudge of one or more dice when the nudge bonus feature is activated. Finally, the method includes evaluating the dice outcome in process 1240 to determine awards or other features.

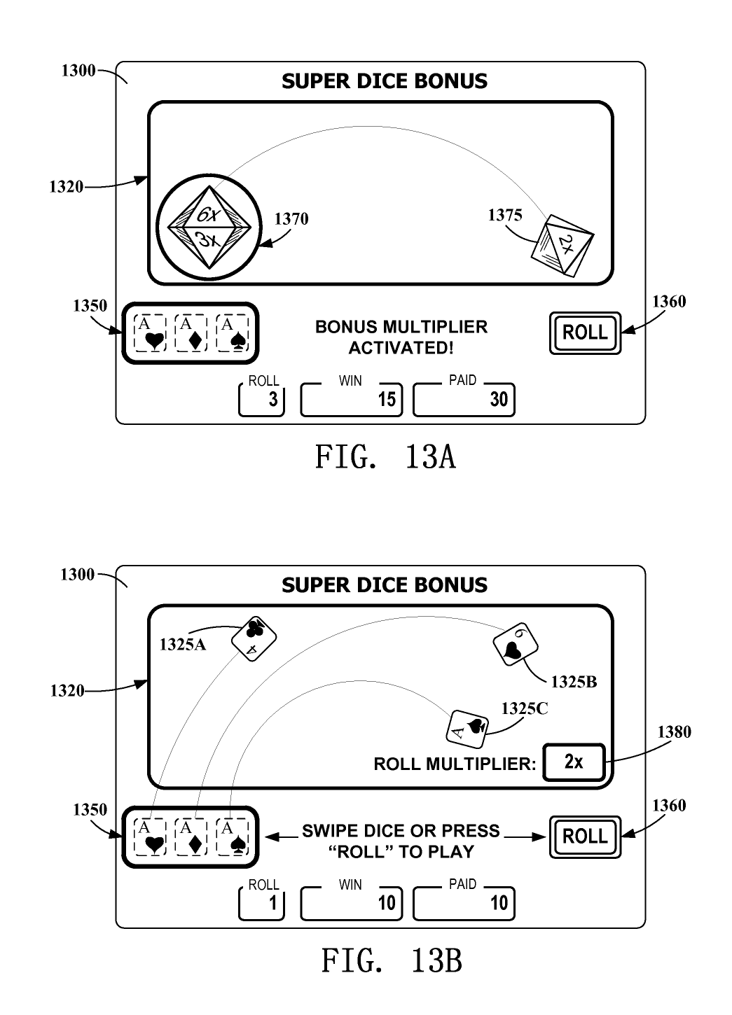

FIGS. 13A-13B illustrate another game feature using multi-positional game elements according to embodiments of the invention. Referring to FIGS. 13A and 13B, a game display 1300 includes a game play area 1320, a roll box 1350, and a roll button 1360, which are all similar to features described above. In this embodiment, however, a 10-sided multiplier die can be received at random prior to play of a gaming event. Although these figures shown the multiplier die as being used before a three dice poker gaming event, it could be used prior to any gaming event, such as a base or primary slot game or video poker game. Alternatively, the multiplier dice could be used during or after a gaming event and then applied to or used with the next game.

The 10 sided multiplier die 1375 may be originally positioned in a bonus circle 1370 where a player can press the circle or swipe the die to roll it in the game play area 1320. Here, some of the sides of the multiplier die 1375 may be blank to represent no additional multiplier, or every side of the die may have multiplier values. The multiplier values may be randomly selected from a weighted table of multiplier values or the values may be otherwise predetermined. Although a 10 sided die is shown as the multiplier die 1375 in FIG. 13A, any multi-positional game element with two or more sides may be used. In this embodiment, the multiplier die 1375 has been rolled to show a “2×” multiplier. A three card poker game using multi-positional game elements 1325A, 1325B, 1325C is then played with a “2×” multiplier as shown in the multiplier meter 1380. In embodiments where multiple rolls are part of the same bonus game, the “2×” multiplier may stay active until the bonus ends. Alternatively, the multiplier may be only used for one roll, but may be triggered before any of the rolls.

FIGS. 14A-14D illustrate another game progression using multi-positional game elements according to embodiments of the invention. Here, multi-positional game elements are rolled over a primary game, where resulting game symbols replace symbols on the primary game grid. Referring to FIGS. 14A-14D, a game display 1400 includes a game grid 1410 having a plurality of slot reels with symbols. Here, after a primary game is played using the reels of the game grid 1410, a bonus may be randomly triggered (or triggered based on a condition associated with the game event) where a player is allowed to roll one or more multi-positional game elements over the game grid 1410. As shown in FIG. 14B, the bonus has been activated and the player is presented a message box 1490 with two multi-positional game elements or dice 1425A, 1425B that can be rolled over the game grid 1410.

Each of the multi-positional game elements 1425A, 1425B has game symbols mapped to the different sides of the game elements. Although two game elements 1425A, 1425B are shown in this embodiment, one, three, or more game elements may be used in different embodiments. In addition, the number of presented game elements may depend on the triggering condition. In FIG. 14C, the multi-positional game elements 1425A, 1425B have been rolled on the game grid 1410 and come to rest. Here, the symbols under the game elements 1425A, 1425B are replaced with the symbols 1435A, 1435B shown on the game elements, as illustrated in FIG. 14D. In some embodiments, the symbol combination of the base game may be evaluated prior to the bonus, and again after the bonus so the player has multiple chances of winning awards, or the symbol combinations may only be evaluated after the dice have been rolled. The landing positions of the game elements 1425A, 1425B may be determined at random, may be chosen with a weighted table, or may be based at least in part on the outcome of the primary game. For example, if a winning combination was already present in a primary game outcome, the symbols associated with the winning combination may be exempt from being covered by the multi-positional game elements 1425A, 1425B. In other embodiments, the resulting symbols on the game elements 1425A, 1425B may be moved to replace symbols on the game grid 1410. For example, the game elements 1425A, 1425B may be moved to optimal positions on the game grid 1410, rather than be positionally-related to the symbol they replace in order to give the player the best symbol combinations possible.

As may now be readily understood, one or more devices may be programmed to play various embodiments of the invention. The present invention may be implemented as a casino gaming machine or other special purpose gaming kiosk as described hereinabove, or may be implemented via computing systems operating under the direction of local gaming software, and/or remotely-provided software such as provided by an application service provider (ASP). The casino gaming machines utilize computing systems to control and manage the gaming activity. An example of a representative computing system capable of carrying out operations in accordance with the invention is illustrated in FIG. 15.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 1500 of FIG. 15 is an example computing structure that can be used in connection with such electronic gaming machines, computers, or other computer-implemented devices to carry out operations of the present invention.

The example computing arrangement 1500 suitable for performing the gaming functions in accordance with the present invention typically includes a central processor (CPU) 1502 coupled to random access memory (RAM) 1504 and some variation of read-only memory (ROM) 1506. The ROM 1506 may also represent other types of storage media to store programs, such as programmable ROM (PROM), erasable PROM (EPROM), etc. The processor 1502 may communicate with other internal and external components through input/output (I/O) circuitry 1508 and bussing 1510, to provide control signals, communication signals, and the like.

The computing arrangement 1500 may also include one or more data storage devices, including hard and floppy disk drives 1512, CD-ROM drives 1514, card reader 1515, and other hardware capable of reading and/or storing information such as DVD, etc. In one embodiment, software for carrying out the operations in accordance with the present invention may be stored and distributed on a CD-ROM 1516, diskette 1518, access card 1519, or other form of computer readable media capable of portably storing information. These storage media may be inserted into, and read by, devices such as the CD-ROM drive 1514, the disk drive 1512, card reader 1515, etc. The software may also be transmitted to the computing arrangement 1500 via data signals, such as being downloaded electronically via a network, such as the Internet. Further, as previously described, the software for carrying out the functions associated with the present invention may alternatively be stored in internal memory/storage of the computing device 1500, such as in the ROM 1506.

The computing arrangement 1500 is coupled to the display 1511, which represents a display on which the gaming activities in accordance with the invention are presented. The display 1511 represents the “presentation” of the video information in accordance with the invention, and may be any type of known display or presentation screen, such as liquid crystal displays, plasma displays, cathode ray tubes (CRT), digital light processing (DLP) displays, liquid crystal on silicon (LCOS) displays, etc.

Where the computing device 1500 represents a stand-alone or networked computer, the display 1511 may represent a standard computer terminal or display capable of displaying multiple windows, frames, etc. Where the computing device is embedded within an electronic gaming machine, the display 1511 corresponds to the display screen of the gaming machine/kiosk. A user input interface 1522 such as a mouse, keyboard/keypad, microphone, touch pad, trackball, joystick, touch screen, voice-recognition system, etc. may be provided. The display 1511 may also act as a user input device, e.g., where the display 1511 is a touchscreen device.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs as known in the art may be implemented using hardware, software operable in connection with the processor 1502, or some combination of hardware and software. The present invention is operable using any known RNG, and may be integrally programmed as part of the processor 1502 operation, or alternatively may be a separate RNG controller 1540.

The computing arrangement 1500 may be connected to other computing devices or gaming machines, such as via a network. The computing arrangement 1500 may be connected to a network server 1528 in an intranet or local network configuration. The computer may further be part of a larger network configuration as in a global area network (GAN) such as the Internet. In such a case, the computer may have access to one or more web servers via the Internet. In other arrangements, the computing arrangement 1500 may be configured as an Internet server and software for carrying out the operations in accordance with the present invention may interact with the player via one or more networks.

Other components directed to gaming machine implementations include manners of gaming participant payment, and gaming machine payout. For example, a gaming machine including the computing arrangement 1500 may also include a hopper controller 1542 to determine the amount of payout to be provided to the participant. The hopper controller may be integrally implemented with the processor 1502, or alternatively as a separate hopper controller 1542. A hopper 1544 may also be provided in gaming machine embodiments, where the hopper serves as the mechanism holding the coins/tokens of the machine. The wager input module 1546 represents any mechanism for accepting coins, tokens, coupons, bills, electronic fund transfer (EFT), tickets, credit cards, smart cards, membership cards, etc., for which a participant inputs a wager amount. It will be appreciated that the primary gaming software 1532 may be able to control payouts via the hopper 1544 and controller 1542 for independently determined payout events.

Among other functions, the computing arrangement 1500 provides an interactive experience to players via input interface 1522 and output devices, such as the display 1511, speaker 1530, etc. These experiences are generally controlled by gaming software 1532 that controls a primary gaming activity of the computing arrangement 1500. The gaming software 1532 may be temporarily loaded into RAM 1504, and may be stored locally using any combination of ROM 1506, drives 1512, media player 1514, or other computer-readable storage media known in the art. The primary gaming software 1532 may also be accessed remotely, such as via the server 1528 or the Internet.

The primary gaming software 1532 in the computing arrangement 1500 is shown here as an application software module. According to embodiments of the present invention, this software 1532 provides a slot game or similar game of chance as described hereinabove. For example, the software 1532 may present, by way of the display 1511, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 1532 may include instructions to provide other functionality as known in the art and described herein, such as shown and described above regarding FIGS. 1-14D.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A gaming device comprising:
a game display for displaying game events;
a player interface device for receiving inputs related to the game events; and
a processor configured to:
receive a wager on a primary game event;
display an outcome of the primary game event on the game display;
determine if a bonus game event is triggered;
when a bonus game event is triggered:
providing a plurality of six-sided game elements,
selecting a number of cards in a deck of cards for use in the bonus game event, the number of selected cards corresponding to six times the number of game elements provided,
assigning each selected card to one of the six positions of the game elements so that each position of each game element is associated with a card,
randomizing the game elements to display one position of each of the game elements,
evaluating a poker hand created by the displayed cards on the displayed positions of the game elements;
determining if a bonus terminating condition has been received, and
repeating the selection of cards, assignment of cards to game elements, randomization of the game elements, and evaluation steps until a bonus terminating condition has been received; and
provide awards associated with the primary game event and bonus game event.

2. The gaming device of claim 1, wherein three six-sided game elements are provided and eighteen cards out of the deck of cards is selected.

3. The gaming device of claim 1, wherein five six-sided game elements are provided and thirty cards out of the deck of cards is selected.

4. The gaming event of claim 3, wherein the processor is further configured to:
receive a selection of none, one, or more game elements to hold during the bonus game event; and
re-randomize any non-held game elements to generate a final poker hand that is evaluated.

5. The gaming device of claim 1, wherein the bonus game event is triggered when a predefined symbol combination appears in the outcome of the primary game event.

6. The gaming device of claim 1, wherein the bonus terminating condition includes receiving a losing poker hand.

7. The gaming device of claim 1, wherein the processor is further configured to mark one of the positions of the game elements with a bonus terminating mark in the bonus game event, and wherein the bonus terminating condition includes receiving the bonus terminating mark on a displayed side of a game element.

8. A gaming device comprising:
a game display for displaying game events;
a player interface device for receiving inputs related to the game events; and
a processor configured to:
select a portion of cards in a deck of cards;
assign the selected portion of cards to positions on one or more multi-positional game elements;
randomize the one or more multi-positional game elements to display at least one position of each of the one or more multi-positional game elements, each displayed position associated with a card;
evaluate a poker hand created by the displayed cards on the one or more displayed positions of the one or more multi-positional game elements; and
provide awards associated with the evaluation of the poker hand.

9. The gaming device of claim 8, wherein
receive a selection of none, one, or more game elements to hold; and
re-randomize any non-held game elements to generate a final poker hand that is evaluated.

10. The gaming device of claim 9, further comprising selecting new cards to display on positions of the non-held game elements prior to re-randomizing the non-held game elements.

11. The gaming device of claim 8, wherein the processor is further configured to:
display a plurality of sets of multi-positional game elements; and
receive a selection of one of the plurality of sets of multi-positional game elements.

12. The gaming device of claim 8, wherein selecting a portion of cards in a deck of cards includes:
determining if the selected cards meets a predefined rule; and
reselecting at least one of the cards until all the selected cards meets the predefined rule.

13. The gaming device of claim 8, wherein assigning the selected portion of cards to positions on one or more multi-positional game elements includes:
determining if the assigned cards meets a predefined rule; and
reassigning at least one of the cards until all the assigned cards meets the predefined rule.

14. The gaming device of claim 8, wherein the processor is further configured to:
determine if a nudge feature is triggered; and
when a nudge feature is triggered:
determining which game elements are eligible to be nudged,
providing a card viewer for each eligible game element to show other cards associated with each position of the eligible game element,
receiving a selection of a game element to nudge, and
randomly selecting a new position of the selected game element to display.

15. The gaming device of claim 14, wherein a game element is eligible to be nudged when it has not been held.

16. A method of operating a gaming device having a game display, game processor, and a player input device, the method comprising:
providing at least one multi-positional game element having a plurality of positions;
providing a plurality of eligible symbols;
mapping at least a portion of the plurality of eligible symbols to each position of the at least one multi-positional game element, wherein mapping at least a portion of the plurality of eligible symbols includes selecting symbols at random to map to each position of the at least one multi-positional game element;
randomizing the multi-positional game element to display at least one position of the multi-positional game element; and
evaluating the one or more symbols respectively associated with the at least one displayed position of the multi-positional game element to determine awards.

17. The method of claim 16, further comprising:
determining if the mapped symbols on the at least one multi-positional game element satisfies a predefined rule; and
remapping symbols to each position of the at least one multi-positional game element when the predefined rule is not satisfied.

18. The method of claim 17, wherein the predefined rule requires a game element to not include identical symbols in multiple positions of the game element.

19. The method of claim 16, wherein the eligible symbols are arranged in a weighted table, and wherein mapping at least a portion of the plurality of eligible symbols to each position of the at least one multi-positional game element includes selecting the eligible symbols from the weighted table.

20. The method of claim 16, wherein multiple multi-positional game elements are provided, and wherein evaluating the one or more symbols respectively associated with the at least one displayed position of the multi-positional game element to determine awards includes evaluating each permutation of the symbols respectively associated with the displayed positions.
